(19) United States
(12) Patent Application Publication
(10) Pub. No.: US 2026/0271068 A1
(43) Pub. Date: Sep. 10, 2026

(54) HANDLING TEMPORARY STATION UNAVAILABILITY IN WI-FI

(71) Applicant: Samsung Electronics Co., Ltd., Suwon-si (KR)

(72) Inventors: Vishnu Vardhan Ratnam, Frisco, TX (US); Boon Loong Ng, Plano, TX (US); Rubayet Shafin, Frisco, TX (US); Peshal Nayak, Plano, TX (US); Yue Qi, Plano, TX (US); Bilal Sadiq, Frisco, TX (US)

(21) Appl. No.: 19/552,964

(22) Filed: Feb. 27, 2026

Related U.S. Application Data
(60) Provisional application No. 63/768,337, filed on Mar. 7, 2025.
(60) Provisional application No. 63/774,523, filed on Mar. 19, 2025.

(51) Int. Cl. H04W 74/0816; H04L 1/00; H04W 74/0833

(52) U.S. Cl. CPC H04W 74/0816; H04L 1/0003; H04W 74/085

(57) ABSTRACT

Methods and apparatuses for handling temporary station unavailability in Wi-Fi. A method performed by a station (STA) includes obtaining a transmit opportunity (TXOP) to initiate transmission of a frame to a second STA, determining that the second STA is temporarily unavailable for receiving the frame, and taking necessary action until the second STA is available to receive the frame.

### CROSS-REFERENCE TO RELATED APPLICATION(S) AND CLAIM OF PRIORITY

This application claims priority under 35 U.S.C. § 119(e) to U.S. Provisional Patent Application No. 63/768,337, filed on Mar. 7, 2025, and U.S. Provisional Patent Application No. 63/774,523, filed on Mar. 19, 2025. The above identified provisional patent applications are hereby incorporated by reference in their entirety.

### TECHNICAL FIELD

This disclosure relates generally to wireless communication, and more specifically to handling temporary station unavailability in Wi-Fi.

### BACKGROUND

Wireless Local Area Network (WLAN) technology allows devices to access the internet in the 2.4 GHZ, 5 GHz, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for handling temporary station unavailability in Wi-Fi.

In one embodiment, a method performed by a station (STA) includes obtaining a transmit opportunity (TXOP) to initiate transmission of a frame to a second STA. The method includes determining that the second STA is temporarily unavailable for receiving the frame, and taking necessary action until the second STA is available to receive the frame.

In another embodiment, an electronic device comprises at least one processor including processing circuitry, and memory storing instructions. The instructions, when executed by the at least one processor individually or collectively, cause the electronic device to obtain a TXOP to initiate transmission of a frame from a first STA to a second STA. The instructions, when executed by the at least one processor individually or collectively, cause the electronic device to determine that the second STA is temporarily unavailable for receiving the frame. The instructions, when executed by the at least one processor individually or collectively, cause the electronic device to take necessary action until the second STA is available to receive the frame.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example access point (AP) according to embodiments of the present disclosure;

FIG. 2B illustrates an example station (STA) according to embodiments of the present disclosure;

FIG. 3 illustrates an example illustration of enhanced multi-link single radio (EMLSR) operation for a two-link non-AP multi-link device (MLD) according to embodiments of the present disclosure;

FIG. 4 illustrates an example scenario where a STA wins channel contention but intends to defer transmission due to unavailability of one of the recipient STAs according to embodiments of the present disclosure;

FIG. 5 illustrates an example padding frame according to embodiments of the present disclosure;

FIG. 6 illustrates an example padding frame as an action no ack frame of category ultra-high reliability (UHR) according to embodiments of the present disclosure;

FIG. 7 illustrates an example of a padding aggregated media access control protocol data unit (A-MPDU) for reservation of medium time according to embodiments of the present disclosure;

FIG. 8 illustrates an example of a padding physical layer protocol data unit (PPDU) for reservation of medium time according to embodiments of the present disclosure;

FIG. 9 illustrates an example of a scenario where STA2 becomes temporarily unavailable after the end of a frame exchange with STA1, due to the operating mode of STA2, according to embodiments of the present disclosure;

FIG. 10 illustrates an example of a first STA initiating channel contention immediately after completed non-primary channel access (NPCA) switch and using a padding frame to reserve medium time until the intended recipients of the initial frame have completed the NPCA switch according to embodiments of the present disclosure;

FIG. 11 illustrates an example of a trigger-based NPCA transmission with only the AP participating in channel contention according to embodiments of the present disclosure;

FIG. 12 illustrates an example of a trigger-based NPCA transmission with all NCPA STAs participating in channel contention according to embodiments of the present disclosure;

FIG. 13 illustrates an example of an AP winning channel contention in a non-trigger based NPCA transmission according to embodiments of the present disclosure;

FIG. 14 illustrates an example of a non-AP winning channel contention in a non-trigger based NPCA transmission according to embodiments of the present disclosure;

FIG. 15 illustrates an example of STA1 deferring transmission to STA2 after winning channel contention by transmitting a padding frame, due to co-existence based unavailability of STA2 according to embodiments of the present disclosure;

FIG. 16 illustrates an example of the protection of the medium to aid a receiving dynamic power save (DPS) STA to transition to a low power state after the end of a frame exchange according to embodiments of the present disclosure;

FIG. 17 illustrates an example of the protection of the medium to aid a transmitting DPS STA to transition to a low power state after the end of a frame exchange according to embodiments of the present disclosure;

FIG. 18 illustrates an example of the protection of the medium to aid a receiving dynamic sub-band operation (DSO) STA to transition to switch back to the primary channel after the end of a frame exchange according to embodiments of the present disclosure;

FIG. 19 illustrates a flow diagram of a method performed by a STA that initiates a transmit opportunity (TXOP) when an intended recipient is unavailable for a fixed duration according to embodiments of the present disclosure;

FIG. 20 illustrates a flow diagram of a method performed by a STA that reserves medium time when a peer STA becomes unavailable to prevent the peer STA from suffering from loss of medium synchronization according to embodiments of the present disclosure;

FIG. 21 illustrates a flow diagram of a method performed by a STA that has an upcoming unavailability schedule according to embodiments of the present disclosure; and

FIG. 22 illustrates an example method performed by a STA in a wireless communication system according to embodiments of the present disclosure.

### DETAILED DESCRIPTION

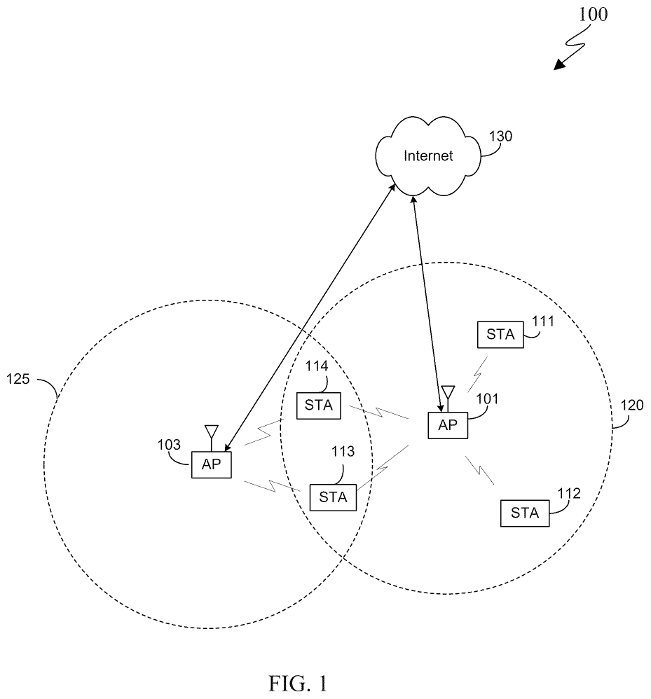

FIGS. 1 through 22, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE 802.11-2020, “Wireless LAN Medium Access Control (MAC) and Physical Layer (PHY) Specification;” [2] IEEE P802.11ax/D8.0; [3] IEEE P802.11be/D7.0; [4] IEEE P802.11bn/D0.1; [5] 11-23/1965r0-Dynamic Power Save follow up; [6] 11-22/2204r0, “UHR Dynamic Subband Operation;” [7] 11-23-0034-01-0uhr-non-primary-channel-utilization.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes AP devices 101 and 103. The AP devices 101 and 103 communicate with at least one network 130, such as the Internet, a proprietary Internet Protocol (IP) network, or other data network. The AP device 101 provides wireless access to the network 130 for a plurality of STAs 111-114 within a coverage area 120 of the AP device 101. The AP devices 101-103 may communicate with each other and with the STAs 111-114 using Wi-Fi or other WLAN communication techniques. In various embodiments of this disclosure, each of the APs 101 and 103 and each of the STAs 111-114 may be an MLD.

Depending on the network type, other well-known terms may be used instead of “access point” or “AP device,” such as “router” or “gateway.” For the sake of convenience, the term “AP device” is used in this disclosure to refer to network infrastructure components that provide wireless access to remote terminals. In WLAN, given that the AP device also contends for the wireless channel, the AP device may also be referred to as a STA (e.g., an AP device STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP device or contends for a wireless channel in a WLAN, whether the STA is a mobile device (such as a mobile telephone or smartphone) or is normally considered a stationary device (such as a desktop computer, AP device, media player, stationary sensor, television, etc.). This type of STA may also be referred to as a non-AP device STA.

Dotted lines show the approximate extents of the coverage areas 120 and 125, which are shown as approximately circular for the purposes of illustration and explanation only. It should be clearly understood that the coverage areas associated with AP devices, such as the coverage areas 120 and 125, may have other shapes, including irregular shapes, depending upon the configuration of the AP devices and variations in the radio environment associated with natural and man-made obstructions.

As described in more detail below, one or more of the AP devices may include circuitry and/or programming for supporting handling temporary station unavailability in Wi-Fi. Although FIG. 1 illustrates one example of a wireless network 100, various changes may be made to FIG. 1. For example, the wireless network 100 could include any number of AP devices and any number of STAs in any suitable arrangement. Also, the AP device 101 could communicate directly with any number of STAs and provide those STAs with wireless broadband access to the network 130. Similarly, each AP device 101-103 could communicate directly with the network 130 and provide STAs with direct wireless broadband access to the network 130. Further, the AP devices 101 and/or 103 could provide access to other or additional external networks, such as external telephone networks or other types of data networks.

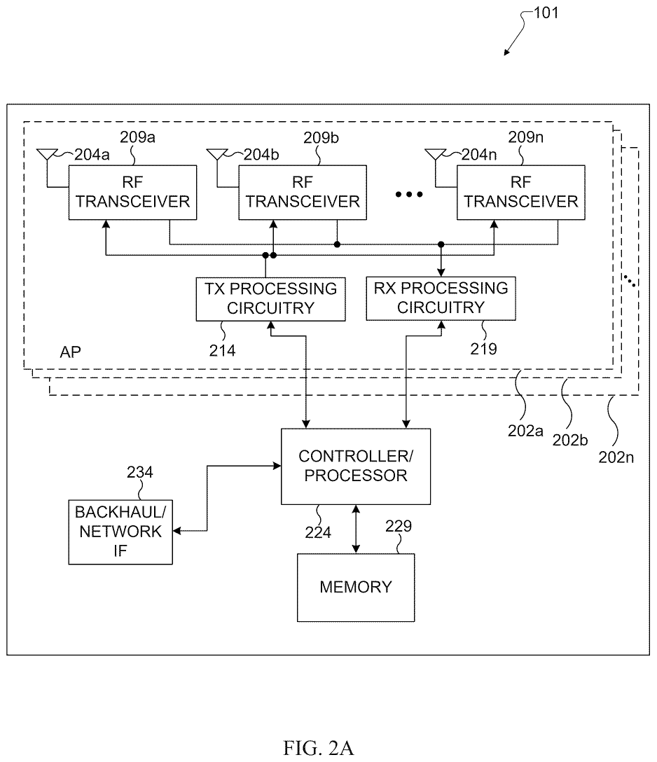

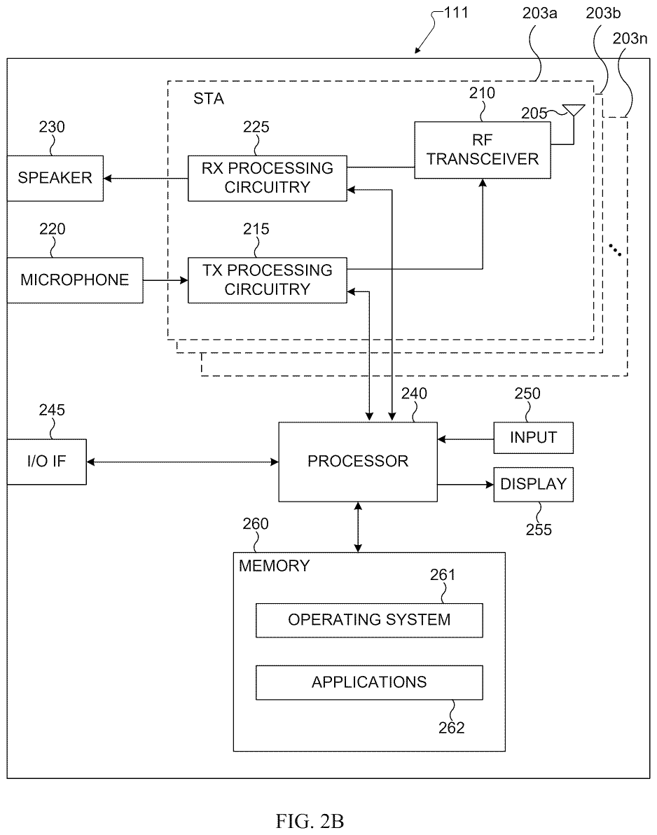

FIG. 2A illustrates an example AP device 101 according to various embodiments of the present disclosure. The embodiment of the AP device 101 illustrated in FIG. 2A is for illustration only, and the AP device 103 of FIG. 1 could have the same or similar configuration. However, AP devices come in a wide variety of configurations, and FIG. 2A does not limit the scope of this disclosure to any particular implementation of an AP device.

As shown in FIG. 2A, the AP 101 includes multiple antennas 204a-204n, multiple RF transceivers 209a-209n, transmit (TX) processing circuitry 214, and receive (RX) processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 may be affiliated with multiple APs 202a-202n and could include any number of each component shown in FIG. 2A. As a particular example, an access point could include a number of interfaces 234, and the controller/processor 224 could support routing functions to route data between different network addresses. As another particular example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B illustrates an example STA 111 according to this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

As shown in FIG. 2B, the STA 111 includes antenna(s) 205, a radio frequency (RF) transceiver 210, TX processing circuitry 215, a microphone 220, and receive (RX) processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to provide management of channel sounding procedures in WLANs. In some embodiments, the controller/processor 240 includes at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. For example, the STA 111 may be affiliated with multiple STAs 203a-203n. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

Various embodiments of the present disclosure recognize that in the discussions for the latest Wi-Fi standard IEEE 802.11bn, modes of operation have been designed for Wi-Fi devices, wherein the device may be temporarily unavailable for communication for a short duration of time. This unavailability can be for one or more of: transmission, reception, channel sensing, etc. Examples of such modes are:
Dynamic Power Save (DPS) [4] [5]: A DPS STA may require some time to transition from a low power state to high power state or vice versa. These delays are called the DPS Padding delay and DPS Transition delay, and they are indicated by the DPS STA when enabling DPS mode. During the DPS Padding delay and/or DPS Transition delay, the DPS STA may not be capable of transmission and/or reception and/or channel sensing.
Dynamic Sub-band Operation (DSO) [4] [6]: When a DSO STA is allocated resources on a DSO sub-band via an initial control frame, the DSO STA may require some time to perform the channel switch to the allocated sub-band. Similarly, at the end of the transmission on the DSO sub-band the STA may require some time to switch back to the primary channel. These delays are called the DSO Padding delay and DSO Transition delay, and they are indicated by the DSO STA when enabling DSO mode. During the DSO Padding delay and/or DSO Transition delay, the DSO STA may not be capable of transmission and/or reception and/or channel sensing.
Non-primary Channel Access (NPCA) [4] [7]: When an NPCA STA (AP or non-AP) observes an NPCA trigger event on the primary channel, the STA may switch to the NPCA backup primary channel for performing transmissions. The STA may then switch back to the primary channel at the appropriate time. The NPCA STA may require some time to perform this switch and switch back operation, called the NPCA Switch delay and NPCA Switchback delay, and they are indicated by the NPCA STA when enabling NPCA mode. During the NPCA Switch delay and NPCA Switchback delay, the NPCA STA may not be capable of transmission and/or reception and/or channel sensing.
Coexistence indication [4]: When a STA (AP or non-AP) enables periodic or dynamic unavailability indication, it may indicate a time window during which the STA is not capable of transmission and/or reception and/or channel sensing.

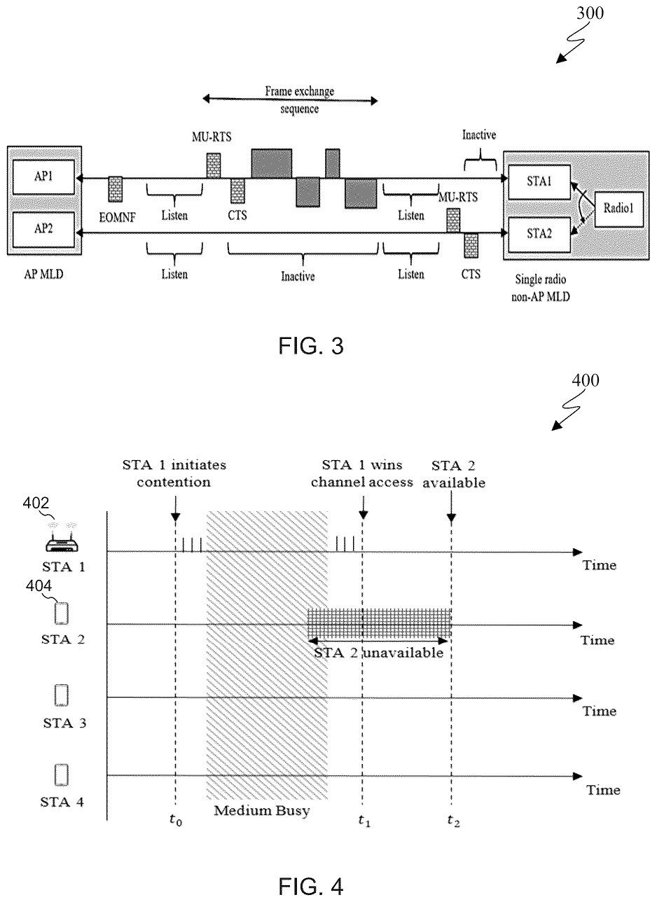

Even in older Wi-Fi standards there were several features, wherein a device may be temporarily unavailable for communication for a short duration of time. This unavailability can be for one or more of: transmission, reception, channel sensing, etc. Examples of such modes are:
Operating mode change [1-2]: When an AP or a non-AP STA performs an operating mode change to change the supported bandwidth, number of spatial streams etc., there may be a temporary interval of time during which the STA is not capable of transmission and/or reception and/or channel sensing. Any transmission initiated with the STA during this time has a higher chance of not being received correctly.
Non-simultaneous transmit receive (NSTR) operation [3]: A 802.11be multi-link device (MLD) may suffer from a non-simultaneous transmit receive constraint between a pair of its links. In this case, when the device is transmitting on any one of the two links, it may be incapable of receiving frames or performing channel sensing on the other link due to self-interference from the transmitting link.
Enhanced Multi-link Single Radio (EMLSR) operation [3]: A 802.11be multi-link device (MLD) may operate in EMLSR mode on two or more links, during which the STAs operating on the links are only capable of receiving initial control frames. However, after receiving the initial control frame on one such link, the MLD may move its other radios to that link to be capable of supporting a larger bandwidth and a larger number of spatial streams. At the end of the transmission the radios may again be moved back to their respective links. This moving of radios into the link and out of the link may require some time, called the EMLSR Padding delay and EMLSR Transition delay, respectively. The EMLSR MLD indicates these delays when enabling the EMLSR mode. During the EMLSR Padding delay and the EMLSR Transition delay, the EMLSR STAs may not be capable of transmission and/or reception and/or channel sensing. In addition, during the whole time when transmission to the EMLSR MLD is happening on one EMLSR link, the STAs of the MLD operating on the other EMLSR links may not be capable of transmission and/or reception and/or channel sensing.
   This operation is illustrated in FIG. 3, which illustrates an example of EMLSR operation for a two-link non-AP MLD 300 according to embodiments of the present disclosure. The embodiment of an example of EMLSR operation for a two-link non-AP MLD of FIG. 3 is for illustration only. Different embodiments of an example of EMLSR operation for a two-link non-AP MLD could be used without departing from the scope of this disclosure.

In several of these features, the indicated unavailability times may be different for each STA, based on their implementation.

Various embodiments of the present disclosure recognize that in several operation modes, a Wi-Fi STA may be temporarily unavailable for transmission, reception, or both. Correspondingly, there may be situations where one STA wins a transmit opportunity (TXOP) to initiate transmission to other STAs, however one or more of the intended recipients are temporarily unavailable for receiving the frame. In such cases, a mechanism is required for the initiating STA to defer the transmission till the intended recipients are available, without having to forgo the transmit opportunity it has won. Similarly, there may be a need for a mechanism for a STA to reserve medium time while another STA is unavailable, so that the other STA does not suffer from loss of medium synchronization when it becomes available again.

Accordingly, various embodiments of the present disclosure provide solutions for a STA that has won a transmit opportunity to defer the transmission for a short interval while some intended recipients of subsequent transmissions are unavailable, without losing the transmit opportunity. Solutions are also provided for a STA to reserve medium time while another STA is unavailable to prevent the other STA from losing medium synchronization.

FIG. 4 illustrates an example scenario where a STA wins channel contention but intends to defer transmission due to unavailability of one of the recipient STAs 400 according to embodiments of the present disclosure. The embodiment of an example scenario where a STA wins channel contention but intends to defer transmission due to unavailability of one of the recipient STAs of FIG. 4 is for illustration only. Different embodiments of an example scenario where a STA wins channel contention but intends to defer transmission due to unavailability of one of the recipient STAs could be used without departing from the scope of this disclosure.

As described herein, there may be several modes of operation where a Wi-Fi STA (AP or non-AP) may be unavailable for a certain time duration. For many of these modes, this unavailable duration is also dependent on implementation, and is disclosed by the STA to its peers when enabling the mode. For ease of explanation, a scenario is provided where a first STA, say STA1 402, initiates channel contention at time t₀, wins the channel access at time t₁ and then intends to transmit data to a few other peer STAs. Among the peer STAs, STA2 404 is unavailable until a time t₂, where t₂>t₁. Correspondingly STA1 402 may intend to defer transmission until t₂ but without losing the channel access opportunity it has won at t₁. This scenario is illustrated in FIG. 4. Note that unavailability herein is used rather generically, and it can mean any combination of being unable to transmit, being unable to receive or being unable to perform channel sensing.

In one embodiment, the standard may disallow deferred transmission by STA1 402, when the transmission by STA1 402 and/or the reason for unavailability by STA2 404 is due to one or more of the features discussed, e.g., NPCA, DPS, DSO, Coexistence, EMLSR, etc. For example, if STA2 404 is unavailable due to coexistence reasons, then STA1 402 may not be permitted to contend for a channel earlier than t₂ for traffic that is addressed to STA2 404. In another example, if STA1 402 wins channel access earlier than t₂ for traffic addressed to STA2 404, then STA2 404 may be required to pick a new back-off counter before initiating the transmission.

In one embodiment, the standard may impose some restrictions on the type of devices that are allowed to defer transmission after winning a TXOP, since an intended receiver is not available. For example, such a mechanism may only be permitted to be used by the Access Point, or Wi-Fi devices beyond a certain Wi-Fi generation, or may be allowed to be used only for specific access categories.

In one embodiment, the standard may impose an upper limit [symbol] on the time between start of channel contention and the recipient STA availability t₂−t₀, such that if t₂−t₀> [symbol] then STA1 402 is not allowed to initiate channel contention at time t₀. In case, of multiple recipients, in one variant, at least one of the recipients must be available by t₀+ [symbol] . In case, of multiple recipients, in another variant, all the recipients must be available by t₀+ [symbol] . In one embodiment, if the back-off counter is stopped due to detection of medium business, then upon resumption of the counter at a time t′₀ after the medium becomes idle, the STA may require to again check if t₂−t′₀≤ [symbol] is satisfied for continuing the back-off. Note that in the case where the medium is busy for a long time the unavailability end time t₂ may be updated.

In one embodiment, the standard may impose an upper limit T on the deferral time t₂−t₁, such that if t₂−t₁>T then STA1 402 is not allowed to transmit to STA2 404 using the TXOP that STA1 402 had won at time t₁. This deferral time T may be a function of the access category for which the channel contention was won. For example, T can be related to the maximum TXOP duration allowed by the standard for that access category. If t₂−t₁≤T, the exact mechanisms of transmission can be as described in below embodiments.

In one embodiment, if the deferral time t₂−t₁ is smaller than a specific threshold τ that is defined by the standard, then STA1 402 may directly start the transmission to the intended STAs at time t₂, if no other transmission is observed to occupy the medium between t₁ and t₂. This can be interpreted as STA1 402 selecting an additional back-off counter at time t₁ such that it counts down to zero at time t₂. In a variant, the transmission start time may be shifted slightly to account for the granularity of the count down timer. As an example, τ=SIFS interval or τ=PIFS interval or τ=DIFS interval, etc.

In one embodiment, STA1 402 may transmit a CTS-to-self frame at time t₁, with the network allocation vector (NAV) duration set to some function ƒ(t₂−t₁). For example, the NAV duration can be set as max{t₂+Δ−t₁−CTSDuration−SIFS, 0}, where CTSDuration is the duration of the PPDU containing the CTS-to-self frame and A is some constant. In a variant of this embodiment, the CTS-to-self frame may set the NAV duration to cover the whole TXOP initiated by STA1 402. This CTS-to-self frame may be transmitted in a specific PPDU format, at a specific MCS and may occupy the full bandwidth on which the TXOP has been won by STA1 402. For example, the CTS-to-self may be transmitted in a non-HT duplicate PPDU format and at MCS0 or a data rate of 6 Mbps. Then a SIFS duration after the end of the NAV duration of the CTS frame, STA1 402 may directly initiate transmission to the intended recipients, without a need for additional contention. In a variant of this embodiment, the STA1 402 may transmit a burst of CTS-to-self frames each separated by a SIFS duration, such that these frames together can occupy the medium for the time between t₁ and t₂. In each successive CTS-to-self frame, the NAV duration may be set differently. For example, in a CTS-to-self frame transmitted at time t*, the NAV may be set to max{t₂+Δ−t*−CTSDuration−SIFS, 0}. In a variant, STA 1 may transmit a different frame than the CTS-to-self frame for performing such medium reservation.

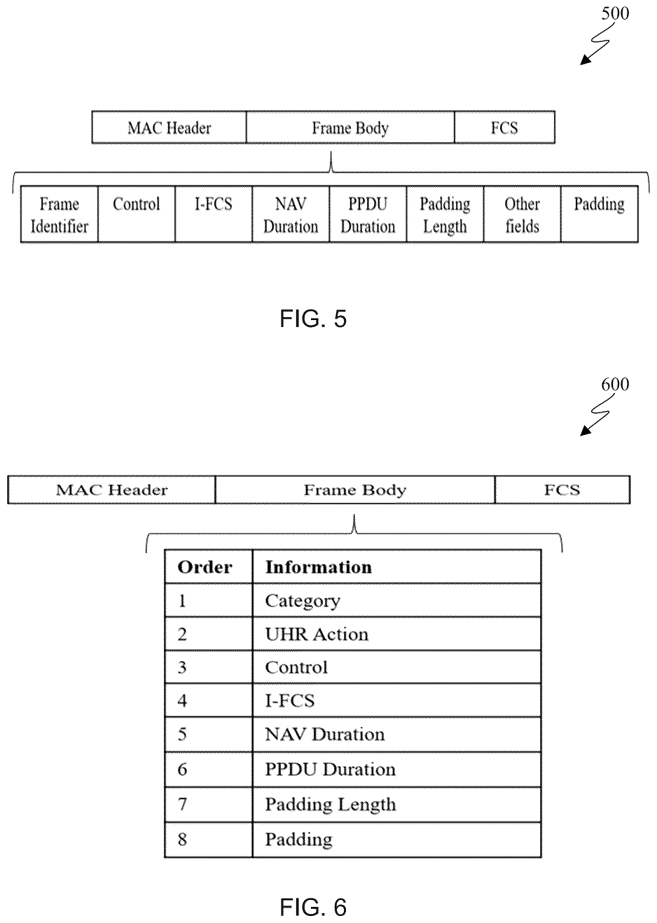

FIG. 5 illustrates an example padding frame 500 according to embodiments of the present disclosure. The embodiment of an example padding frame of FIG. 5 is for illustration only. Different embodiments of an example padding frame could be used without departing from the scope of this disclosure.

FIG. 6 illustrates an example padding frame as an action no ack frame of category UHR 600 according to embodiments of the present disclosure. The embodiment of an example padding frame as an action no ack frame of category UHR of FIG. 6 is for illustration only. Different embodiments of an example padding frame padding frame as an action no ack frame of category UHR could be used without departing from the scope of this disclosure.

In one embodiment, a MAC frame may be transmitted by the transmitting STA on the medium to reserve the medium time for deferred transmissions. This may, for example, be a new MAC frame that may be defined in 802.11bn that is meant for reservation of medium time for deferred transmission. In one variant this MAC frame can be a control frame. In another variant, this frame can be an Action No ACK frame of category UHR or Protected UHR. In other variants this MAC frame can be an Action frame, a management frame, or a data frame. In yet another case, the Padding frame may be an existing frame or a new version/variant of an existing frame type. The MAC frame can be called, for example a Padding frame, or Medium Reservation frame, or Transmission Deferral frame, etc. The Padding frame can carry padding bits within the frame, and can be included in a PPDU with or without aggregation for reserving medium time. The Padding frame may include, one or more of:
MAC header: This field can be the MAC header defined in the Wi-Fi standard, and can include the transmit and receive addresses, duration field, etc., among other things.
Frame identifier: An identifier field that identifies the frame as a Padding frame.
Control field: This field may indicate the sub-type of the Padding frame, the intent of the padding frame, and can indicate the presence of the optional fields present in the Padding frame.
Intermediate-FCS field: This field may carry the frame check sequence (FCS) value to help perform the cyclic redundancy check (CRC) on the Padding frame, based on the fields of the frame present before the Intermediate-FCS field. The presence of this field can help a receiving STA perform an early CRC on a received Padding frame before the end of the frame.
NAV Duration field: This field can carry an indication of the duration of the TXOP that will be operated by the AP. Note that in the embodiment where the Duration field in the MAC header is set to 0, this NAV Duration field may carry the actual duration for which the TXOP will be operated.
PPDU duration field: This field can carry an indication of the time for which the PPDU containing the padding field occupies the medium. This can be similar to the L-SIG field in the PHY header of the PPDU but may have a higher precision or granularity of indication.
Padding length field: This field can carry an indication of the length of the Padding field present in the Padding frame. The length can be measured, for example, in octets.
Padding field: These are the bulk of the payload of the MAC frame, which are responsible for occupying the medium time. The length of this Padding field can be in multiples of octets.
FCS field: This is the frame check sequence defined in Wi-Fi standard that helps the receiver perform the CRC check at the end of the Padding frame.

In a variant, the Padding frame may also have an indication of one or more of: whether the AP intends to poll the non-AP STAs for transmission, whether the transmission will be for uplink and/or downlink direction, the access categories to be used for transmission and when the polling or initial control frame will be sent. An illustration of the Padding frame is shown in FIG. 5. An example of the Padding frame as an Action No Ack frame of category UHR is depicted in FIG. 6. The appropriate duration of the PPDU to cover till the deferred transmit time may be indicated in the PHY header of the PPDU containing the Padding frame. The size of the Padding frame can be determined based on one or more of:
The desired duration of the PPDU,
Bandwidth of transmission,
MCS used for transmission,
The PHY format of the transmitted PPDU
Size of PHY header and/or its duration,
Size of PHY tail bits and/or its duration,
Size of MAC header

For example, the size of the Padding field is given by:

$$PaddingSize = DataRate \times ( PpduDuration - PhyHeaderDuration - PhyTailDuration ) - MacHeaderSize ,$$

where DataRate is the data rate of the transmission determined by the PPDU format, its bandwidth and the MCS used.

The Padding frame, when transmitted by STA1, may have several features:
Transmit Address: The Transmit Address of the Padding frame may be set to the MAC address of STA1.
Receive Address: In one variant of this embodiment, the Receive Address may be set to the MAC address of STA1. In another variant, the receive address may be set to the Broadcast MAC address.
NAV Duration: In one variant of this embodiment, the Duration field in the MAC header of the Padding frame may be set to 0. In another variant, the Duration field may be set to the duration for which the TXOP will be operated by STA1.
PPDU format: In one variant of this embodiment the Padding frame may be sent in a specific pre-determined PPDU format. For example, the frame may be transmitted in non-HT duplicate PPDU format over the whole bandwidth on which the TXOP has been won.
PPDU length: In one variant of this embodiment, the length of the Padding MAC frame can be determined such that the duration of the PPDU containing the frame is at least as long as t₂−t₁−SIFS duration.
MCS Selection: In one variant of this embodiment, the Padding MAC frame shall be transmitted at a fixed modulation and coding scheme (MCS). For example, the frame may be transmitted at MCS0, or at 6 Mbps data rate.
Frame length: In one variant of this embodiment, the length of the Padding field of the Padding frame can be determined such that at the MCS selected for the transmission, the PPDU duration is at least as long as t₂−t₁−SIFS.
ACK policy: In one variant of this embodiment, the Padding frame may not solicit a response or an acknowledgement. In other words, it may have a No Ack policy.

In one embodiment, the data to be transmitted to STA2 may not be aggregated in the same PPDU as the Padding frame.

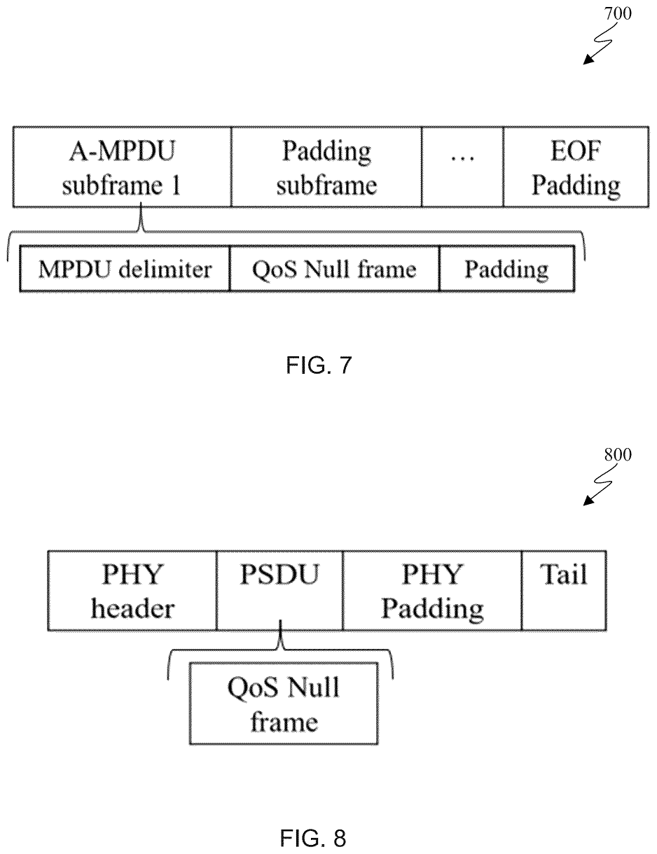

FIG. 7 illustrates an example of a padding A-MPDU for reservation of medium time according to embodiments of the present disclosure. The embodiment of an example of a padding A-MPDU for reservation of medium time of FIG. 7 is for illustration only. Different embodiments of an example of a padding A-MPDU for reservation of medium time could be used without departing from the scope of this disclosure.

In one embodiment, the Padding frame can be generated as an Aggregated MPDU (A-MPDU), with one or more Padding Subframes and/or EOF Padding subframes to generate the A-MPDU of the desired size. These Padding sub-frames may have the MPDU Length set to 0. In one variant of this embodiment, all the subframes of the A-MPDU may be Padding Sub-frames, while in another embodiment, the first A-MPDU subframe may have a MAC frame. This frame can be, for example, a QoS Null frame, where the transmit and receive address in the MAC header are both set to the transmitter (STA1). The size of the Padding fields can be determined based on the duration of the PPDU, bandwidth of transmission, MCS used for transmission, size of PHY header, size of PHY tail bits, size of MAC header and duration of the A-MPDU subframe 1. In one example it can be a MAC frame that does not solicit a response or acknowledgement. In one example this Padding A-MPDU may be transmitted in a specific PHY format such as HT, VHT or HE. An illustration of this Padding A-MPDU is depicted in FIG. 7.

FIG. 8 illustrates an example of a padding physical layer protocol data unit (PPDU) for reservation of medium time 800 according to embodiments of the present disclosure. The embodiment of an example of a padding PPDU for reservation of medium time of FIG. 8 is for illustration only. Different embodiments of an example of a padding PPDU for reservation of medium time could be used without departing from the scope of this disclosure.

In one embodiment, the medium reservation can be generated by transmitting a PPDU and adding PHY Padding within the PPDU after the end of the MAC frame or the PSDU contained within the PPDU. The included MAC frame can be, for example, a QoS Null frame, where the transmit and receive address in the MAC header are both set to the transmitter (STA1). In one example, it can be a MAC frame that does not solicit a response or acknowledgement. In this case, for example, the generated PPDU is referred to as a Padding PPDU. In this case, the PPDU length/duration indication in the PHY header may be set based on the duration of time for which the medium needs to be reserved. The PHY padding bits in the PPDU may cover for the residual time of this PPDU, beyond the end of the included MAC frame. The size of this PHY padding may be determined by the duration of the PPDU, bandwidth of transmission, the MCS used for transmission, size of the PHY header and the size of the PSDU to be transmitted. An illustration of the use of PHY padding to create the Padding PPDU is depicted in FIG. 8. In a variant, the Signal extension field of the PPDU can be used for the medium reservation.

In one embodiment, the Padding frame can be generated by the transmitter (STA1) at the time it wins the channel contention, i.e., at t₁. Correspondingly, in one variant, it may determine the desired size of the Padding frame to cover the duration t₂−t₁−SIFS. In this case, to generate the Padding frame quickly, the transmitter may pre-compute and store the Padding frames corresponding to several different sizes. Correspondingly, the smallest such pre-computed size which is larger than the desired size of the Padding frame may be used by STA1 for the transmission.

In one embodiment, the Padding frame may be generated by the transmitter (STA1) at the time when it initiates channel contention, i.e., at to. Correspondingly, in one variant, it may determine the desired size of the Padding frame to cover the duration t₂−t₀−SIFS. In a variant, the transmitter may recompute the Padding frame again based on the residual time to t₂, where the trigger for the recomputation can be based on one or more of:
The channel access process taking longer than a threshold time after t₀,
The back-off counter at the transmitter crossing below a certain threshold number.

In one embodiment, the backoff counter drawn by the transmitter when initiating the channel access for transmission of the Padding frame can be based on the access category of the buffered traffic that the transmitter intends to deliver to the intended recipients after they become available. In another variant, there may be a pre-defined backoff parameters that are applicable to the Padding frame.

In one embodiment, a STA that receives the Padding frame from STA1, and is not expected to receive the following frames from STA1, may set the basic NAV based on the Duration field of the MAC header of the Padding frame. In another embodiment, the STA may set the basic NAV based on the NAV Duration field of the Padding frame.

A STA that receives a Padding frame from STA1 and that expects to be served by STA1 in the TXOP, should be capable of reception of frames at a SIFS duration after the end of the PPDU containing the Padding frame. In one embodiment, this can be accomplished by the Duration field in the MAC header of the Padding frame being set to 0. In another embodiment where the Duration field protects the whole TXOP, the recipient STA can determine the time to be available based on the L-SIG field of the PHY header or the PPDU Duration field of the Padding frame.

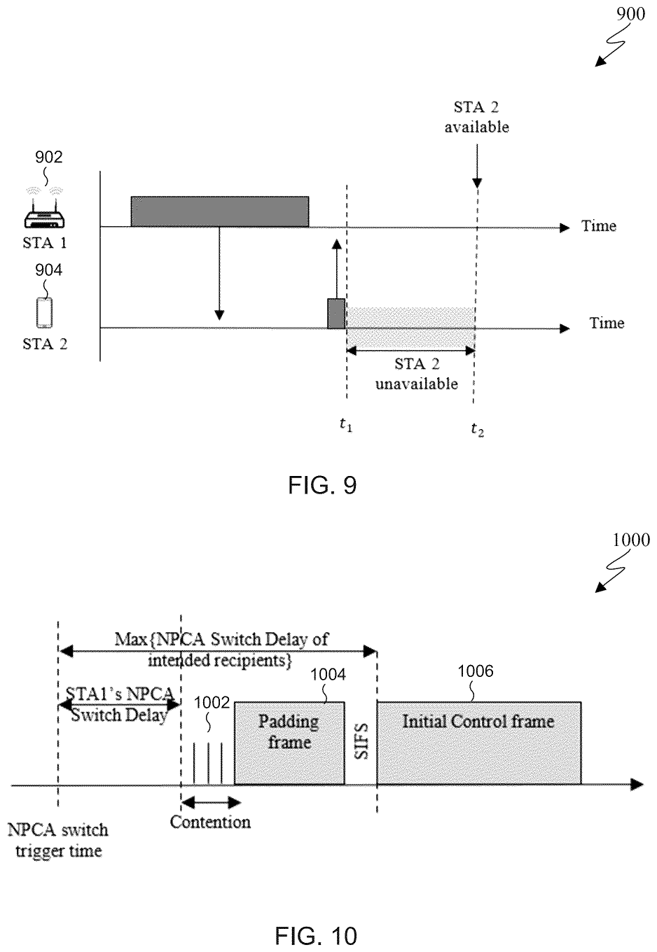

FIG. 9 illustrates an example of a scenario 900 where STA2 becomes temporarily unavailable after the end of a frame exchange with STA1, due to the operating mode of STA2, according to embodiments of the present disclosure. The embodiment of an example scenario where STA2 becomes temporarily unavailable after the end of a frame exchange with STA1, due to the operating mode of STA2, of FIG. 9 is for illustration only. Different embodiments of an example scenario where STA2 becomes temporarily unavailable after the end of a frame exchange with STA1, due to the operating mode of STA2, could be used without departing from the scope of this disclosure.

In various embodiments described herein, the focus was on STA1 reserving the medium to defer the transmission to STA2 while STA2 was unavailable. However, the solutions are also applicable to the case where STA1 902 intends to reserve the medium time while STA2 904 is unavailable, to prevent STA2 904 from losing medium synchronization when it becomes available. This can happen, for example if STA2 904 is a DPS, DSO or EMLSR STA and at the end of the frame exchange with STA1 902, STA2 904 is unavailable for a short time to perform a switch back operation. This example is illustrated in FIG. 9. The solutions for medium reservation discussed above may directly be used in this case as well to reserve the medium time from the start time of unavailability (t₁) to the end of the unavailability (t₂). In this case, a SIFS duration after the frame exchange with STA2 904 ends, STA1 902 may take any of the actions described previously, e.g., send a CTS-to-self frame, or a Padding frame etc., to set the NAV time up to t₂. In one embodiment STA1 902 may provide an indication to STA2 904 whether or not it will provide protection of medium while STA2 904 is unavailable. Correspondingly, STA2 904 may not follow applicable medium synchronization recovery procedures, if STA1 902 indicates that it will provide the medium protection.

FIG. 10 illustrates an example of a first STA initiating channel contention immediately after completed NPCA switch and using a padding frame to reserve medium time until the intended recipients of the initial frame have completed the NPCA switch 1000 according to embodiments of the present disclosure. The embodiment of an example of a first STA initiating channel contention immediately after completed NPCA switch and using a padding frame to reserve medium time until the intended recipients of the initial frame have completed the NPCA switch of FIG. 10 is for illustration only. Different embodiments of an example of a first STA initiating channel contention immediately after completed NPCA switch and using a padding frame to reserve medium time until the intended recipients of the initial frame have completed the NPCA switch could be used without departing from the scope of this disclosure.

When a first NPCA STA (which can be either an AP or a non-AP STA) performs the NPCA switch after an NPCA trigger condition, the first NPCA STA may transmit an initial control frame (ICF) or other frame to one or more peer NPCA STAs to initiate transmission with them. The ICF may be transmitted after the intended recipient(s) have performed the NPCA switch. Note that the NPCA Switch Delay can be different for each NPCA STA, and so the time they complete the NPCA switch can be different even though the NPCA switch trigger time is the same.

In one embodiment, the first NPCA STA may contend for channel access immediately after it has completed the NPCA channel switch and is allowed to participate in the channel contention by meeting any required rules. If it wins the channel contention 1002 before the expected time when the intended recipients of the ICF have completed their channel switch, the first STA may transmit a CTS-to-self frame or a Padding frame 1004 on the medium to keep the medium occupied till the intended recipient NPCA STAs have completed the NPCA switch. The Padding frame 1004 can have one or more features:
In one example, the padding frame may not solicit a response frame,
In one example, the padding frame transmission may end a fixed interval before all NPCA STAs have completed the NPCA switch. For example, this fixed interval can be the short inter-frame spacing (SIFS) interval.
In one example, the padding frame may be addressed to any STA that has completed the NPCA switch already by the time of its transmission. In another example, this frame can be addressed to the first STA itself as the recipient.
In one example, the padding frame can be transmitted in a specific PPDU format and at a specific MCS. For example, it can be transmitted in a non-HT duplicate PPDU format and at a rate of 6 Mbps.
In one example, the padding frame can occupy the whole bandwidth for which the TXOP has been won by the first STA.

After the transmission of the Padding frame 1004, and receiving any applicable response (if applicable), after a SIFS interval gap, the first NPCA STA may transmit the initial control frame 1006 or the initial frame to the original intended recipients. This procedure is illustrated in FIG. 10. In a variant of this embodiment, the first STA may also transmit a CTS-to-self frame before transmitting the Padding frame 1004.

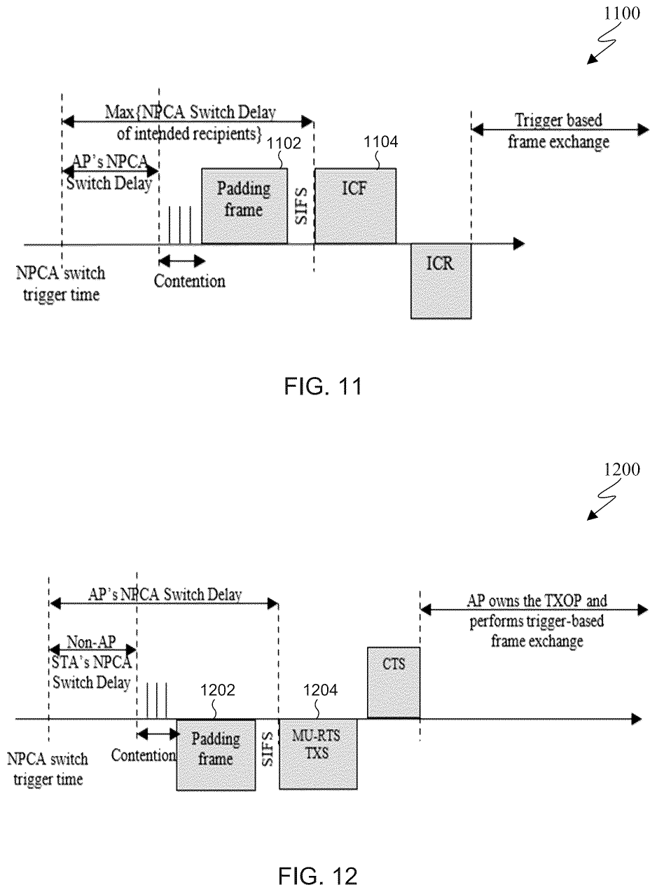

FIG. 11 illustrates an example of a trigger-based NPCA transmission with only the AP participating in channel contention 1100 according to embodiments of the present disclosure. The embodiment of an example of a trigger-based NPCA transmission with only the AP participating in channel contention of FIG. 11 is for illustration only. Different embodiments of an example of a trigger-based NPCA transmission with only the AP participating in channel contention could be used without departing from the scope of this disclosure.

In a variant of the embodiment described herein with respect to FIG. 10, the AP when enabling NPCA in its BSS may indicate a Maximum NPCA Switch Delay for which the transmissions will be deferred on the NPCA backup primary channel. Correspondingly, in this embodiment, the transmission of the initial control frame may only be delayed until the first of the below two conditions are met:
All intended recipients of the initial control frame have completed the NPCA switch operation
The Maximum NPCA Switch Delay has elapsed as counted from the NPCA switch trigger time.

In this case, the STA 1 may only address the initial control frame to recipients whose NPCA Switch Delay is smaller than the Maximum NPCA Switch Delay.

In one embodiment, there may be a mode of NPCA operation during which only trigger-based transmissions may be allowed on the backup channel after performing the NPCA switch. In one embodiment of the trigger-only mode, only the NPCA AP may be permitted to perform channel contention, after NPCA switch and any applicable channel access defer interval. If the AP wins channel contention, the AP may transmit (sequentially):
a Padding frame 1102 to protect medium till intended recipients complete NPCA switch (if applicable),
transmit an initial control frame 1104 to NPCA STAs (if applicable), and
after receiving a response to the initial control frame, initiate trigger-based uplink, or downlink transmission with the NPCA STAs.

This procedure is illustrated in FIG. 11. In a variant of this embodiment, the AP may first transmit a CTS-to-self frame as well before following this sequential procedure.

FIG. 12 illustrates an example of a trigger-based NPCA transmission with all NCPA STAs participating in channel contention 1200 according to embodiments of the present disclosure. The embodiment of an example of a trigger-based NPCA transmission with all NCPA STAs participating in channel contention of FIG. 12 is for illustration only. Different embodiments of an example of a trigger-based NPCA transmission with all NCPA STAs participating in channel contention could be used without departing from the scope of this disclosure.

In another embodiment of the trigger-only mode, any NPCA STA after performing NPCA switch, may be allowed to perform channel contention, after any applicable channel access defer interval.

If the AP wins contention, the AP may transmit (sequentially):
a Padding frame 1202 to protect the medium until intended recipients complete NPCA switch (if applicable),
an initial control frame to NPCA STAs (if applicable), and
after receiving a response to the initial control frame, initiate trigger-based uplink, or downlink transmission with the NPCA STAs.

If a non-AP STA wins channel access, the non-AP STA may transmit (sequentially):
a Padding frame 1202 till the AP has completed the NPCA switch (if applicable), and
an MU-RTS TXS trigger frame 1204 to share the TXOP with the AP.

After this the TXOP is owned by the AP, and it may correspondingly initiate the trigger-based uplink or downlink transmission with NPCA STAs. In one variant of this embodiment, an additional initial control frame exchange may be performed by the non-AP STA with the AP the before the MU-RTS TXS transmission for TXOP sharing. In one variant of this embodiment, the AP may ensure to allocate resources to the non-AP STA which won and shared the TXOP with the AP in the trigger-based transmissions. This procedure is depicted pictorially in FIG. 12. In a variant of this embodiment, the non-AP STA may first transmit a CTS-to-self frame as well before following this sequential procedure.

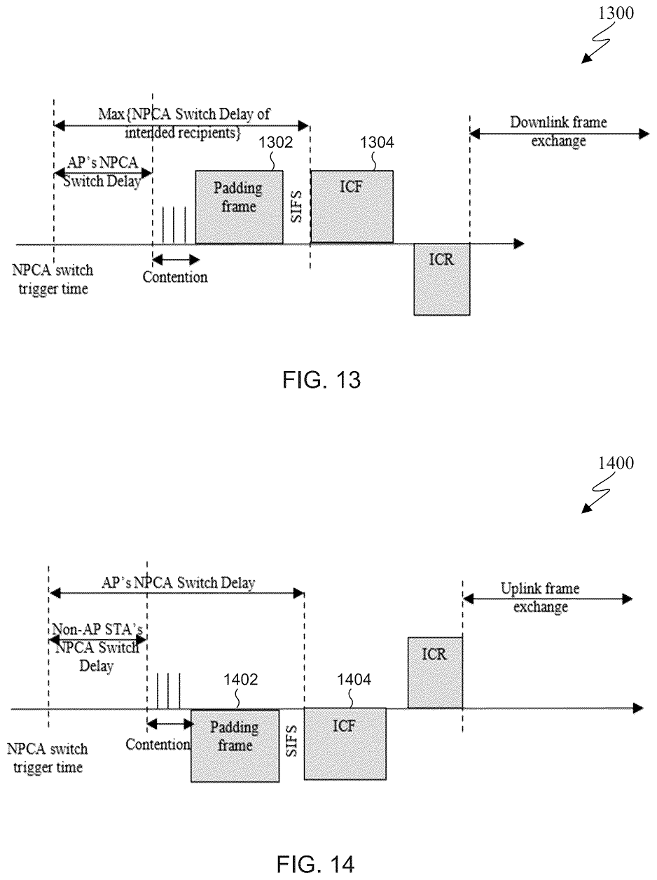

FIG. 13 illustrates an example of an AP winning channel contention in a non-trigger based NPCA transmission 1300 according to embodiments of the present disclosure. The embodiment of an example of an AP winning channel contention in a non-trigger based NPCA transmission of FIG. 13 is for illustration only. Different embodiments of an example of an AP winning channel contention in a non-trigger based NPCA transmission could be used without departing from the scope of this disclosure.

In one embodiment, in one mode of NPCA operation, non-trigger-based transmissions may also be allowed on the backup channel after performing the NPCA switch. In this case, any NPCA STA after performing NPCA switch, may perform channel contention, after any applicable channel access defer interval.

If the AP wins contention, the AP may transmit (sequentially):
a Padding frame 1302 to protect medium till intended recipients complete NPCA switch (if applicable),
an initial control frame 1304 to NPCA STAs (if applicable), and
after receiving a response to the initial control frame, initiate transmission with the NPCA STAs.

This procedure is illustrated in FIG. 13.

FIG. 14 illustrates an example of a non-AP winning channel contention in a non-trigger based NPCA transmission 1400 according to embodiments of the present disclosure. The embodiment of an example of a non-AP winning channel contention in a non-trigger based NPCA transmission of FIG. 14 is for illustration only. Different embodiments of an example of a non-AP winning channel contention in a non-trigger based NPCA transmission could be used without departing from the scope of this disclosure.

If a non-AP STA wins channel access, the non-AP STA may transmit (sequentially):
a Padding frame 1402 until the AP has completed the NPCA switch (if applicable),
transmit an initial control frame 1404 to the AP (if applicable), and
after receiving a response from the AP, initiate transmission to the AP.

This procedure is illustrated in FIG. 14.

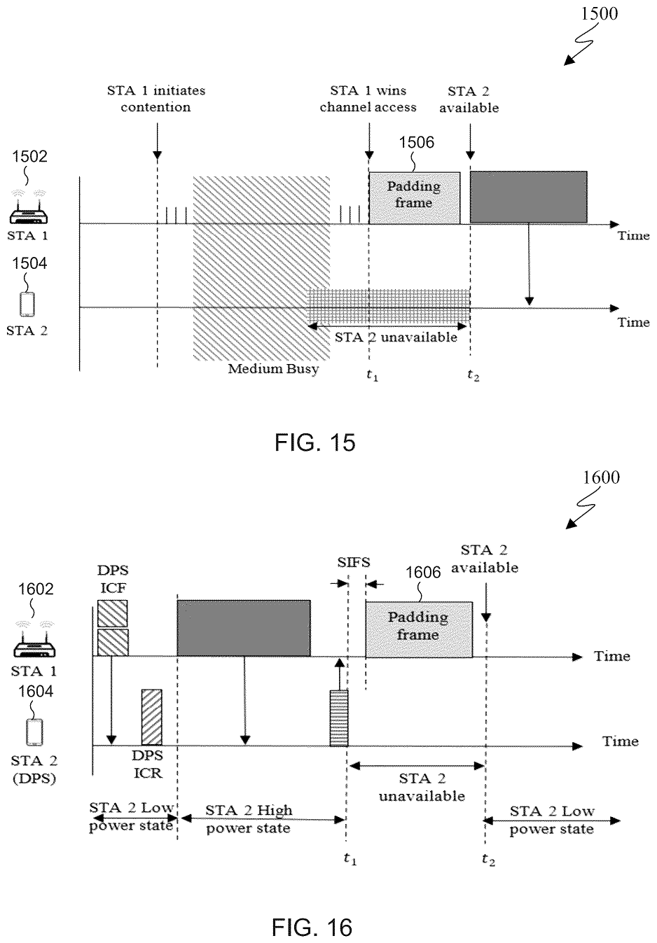

FIG. 15 illustrates an example of STA1 deferring transmission to STA2 after winning channel contention by transmitting a padding frame, due to co-existence based unavailability of STA2 1500 according to embodiments of the present disclosure. The embodiment of an example of STA1 deferring transmission to STA2 after winning channel contention by transmitting a padding frame, due to co-existence based unavailability of STA2 of FIG. 15 is for illustration only. Different embodiments of an example of STA1 deferring transmission to STA2 after winning channel contention by transmitting a padding frame, due to co-existence based unavailability of STA2 could be used without departing from the scope of this disclosure.

In one embodiment, a STA1 1502 may have some traffic available for delivery to STA2 1504 at time t₀. However, via prior co-existence or other unavailability reporting, STA1 1502 may know that STA2 1504 is unavailable until time t₂. In one embodiment, if the time gap t₂−t₀ is above a certain threshold, then STA1 1502 may not initiate the channel contention at time t₀. For example, the required condition can be t₀=t₂. After initiating channel contention, let us consider the case where STA1 1502 wins channel access at time t₁, where t₁<t₂. In one embodiment, if the time gap t₂−t₁ is above a certain threshold, then STA1 1502 may need to pick another back-off counter to perform channel contention. In one embodiment, at time t₁ STA1 1502 may transmit a CTS-to-self frame or a Padding frame 1506 to keep the medium occupied until STA2 1504 becomes available at time t₂. The Padding frame 1506 can have one or more features:
In one example, the padding frame 1506 may not solicit a response frame,
In one example, the padding frame PPDU duration may be long enough to cover the end of the unavailability of STA 2 1504. In one example, the PPDU duration can be at least as long as t₂−t₁−SIFS−Δ, where Δ is a predetermined constant.
In one example, the padding frame 1506 may be addressed to any STA that is available during the duration. In another example, this frame can be addressed to the first STA itself as the recipient.
In one example, the padding frame 1506 can be transmitted in a specific PPDU format and at a specific MCS. For example, it can be transmitted in a non-HT duplicate PPDU format and at a rate of 6 Mbps.
In one example, the Padding frame 1506 can be transmitted only on the primary 20 MHz channel, while in another example, it may occupy the whole bandwidth of the TXOP.

After the transmission of the Padding frame 1506, and receiving any applicable response (if applicable), after a SIFS interval gap, the first STA 1502 may transmit to STA2 1504. This procedure is illustrated in FIG. 15.

FIG. 16 illustrates an example of the protection of the medium to aid a receiving DPS STA to transition to a low power state after the end of a frame exchange 1600 according to embodiments of the present disclosure. The embodiment of an example of the protection of the medium to aid a receiving DPS STA to transition to a low power state after the end of a frame exchange of FIG. 16 is for illustration only. Different embodiments of an example of the protection of the medium to aid a receiving DPS STA to transition to a low power state after the end of a frame exchange could be used without departing from the scope of this disclosure.

In one embodiment, a first STA 1602 may initiate a transmission with a second STA 1604 operating in DPS mode with a DPS initial control frame, that indicates to the second STA 1604 to transition from low power state to high power state. At the end of the frame exchange, after sending the acknowledgement to the first STA 1602, the second STA 1604 may transition back to the low power state. This transition may require a time indicated in the DPS Transition Delay field by the second STA 1604. During this time, the second STA 1604 may be unable to perform channel sensing, and correspondingly may lose medium synchronization if the DPS Transition Delay is above a certain threshold. Correspondingly, in one embodiment, to ensure that the second STA 1604 does not lose medium synchronization, a SIFS duration after receiving the acknowledgement from the second STA 1604, the first STA 1602 may transmit a Padding frame 1606 to keep the medium occupied while the second STA 1604 performs the transition to the low power state. The Padding frame 1606 can have one or more features:
In one example, the padding frame 1606 may not solicit a response frame,
In one example, the padding frame PPDU duration may be long enough to cover the end of the unavailability of STA 2 1604, i.e., the DPS Transition Delay starting from the end of frame exchanges in the high capability state. In one example, this duration can be at least as long as DPS Transition Delay−SIFS duration−Δ, where Δ is a predetermined constant.
In one example, the padding frame 1606 may be addressed to any STA that is available during the duration. In another example, this frame can be addressed to the first STA 1602 itself as the recipient.
In one example, the padding frame 1606 can be transmitted in a specific PPDU format and at a specific MCS. For example, it can be transmitted in a non-HT duplicate PPDU format and at a rate of 6 Mbps.
In one example, the Padding frame 1606 can be transmitted only on the primary 20 MHz channel, while in another example, it may occupy the whole bandwidth of the TXOP.

In one embodiment, such medium reservation using a Padding frame 1606 may be used only under specific circumstances, as defined in the standard. Some examples of such circumstances can include:
The STA2 being of a specific type, e.g., an access point.
The DPS Transition Delay of STA2 being above a certain threshold, e.g., the SIFS duration or the DIFS duration.

An illustration of this frame exchange is illustrated in FIG. 16. In one embodiment, the first STA 1602 may indicate a priori whether it will provide medium protection for the second STA 1604 during its transition delay. In a variant, this indication may be implicit, e.g., the first STA 1602 may announce the maximum supported DPS Transition Delay for which it will provide medium protection. Based on the indication the second STA 1604 may determine whether it has to apply any rules corresponding to loss of medium synchronization after completing the state transition. Note that the medium protection or loss of medium synchronization rules may not apply if the DPS Transition Delay is below a predetermined threshold value indicated by the standard.

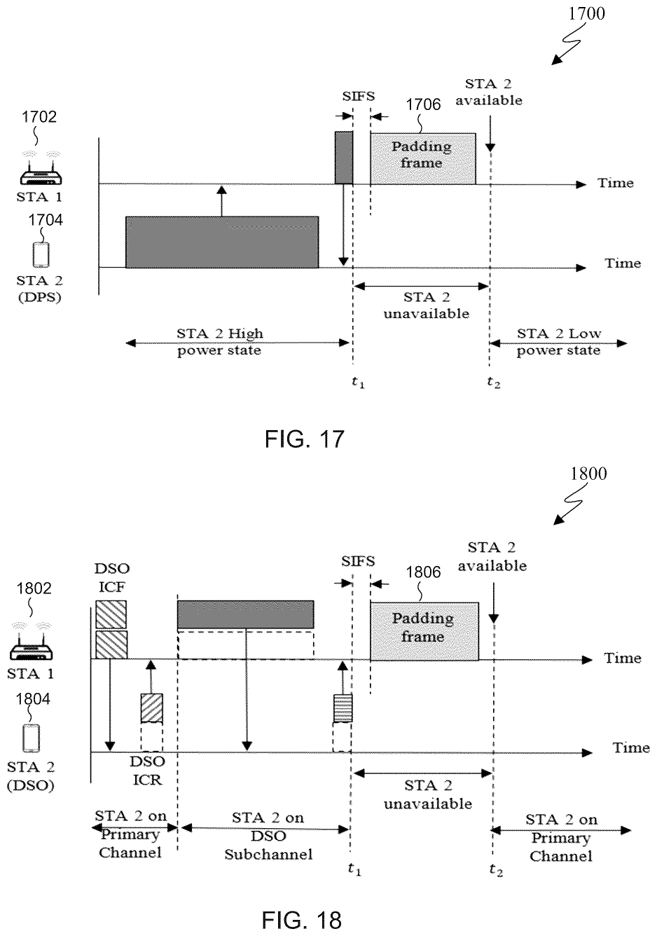

FIG. 17 illustrates an example of the protection of the medium to aid a transmitting DPS STA to transition to a low power state after the end of a frame exchange 1700 according to embodiments of the present disclosure. The embodiment of an example of the protection of the medium to aid a transmitting DPS STA to transition to a low power state after the end of a frame exchange of FIG. 17 is for illustration only. Different embodiments of an example of the protection of the medium to aid a transmitting DPS STA to transition to a low power state after the end of a frame exchange could be used without departing from the scope of this disclosure.

A similar use of a Padding frame 1706 can also be used when the first STA 1702 is a TXOP responder with the second STA 1704 being a TXOP initiator. In this case, after the last frame of the frame exchange, e.g., the ACK frame sent by the first STA 1702 to the second STA 1704, the first STA 1702 may transmit the Padding frame 1706, a SIFS duration after the end of the preceding frame. An illustration of this frame exchange is illustrated in FIG. 17.

FIG. 18 illustrates an example of the protection of the medium to aid a receiving DSO STA to transition to switch back to the primary channel after the end of a frame exchange 1800 according to embodiments of the present disclosure. The embodiment of an example of the protection of the medium to aid a receiving DSO STA to transition to switch back to the primary channel after the end of a frame exchange of FIG. 18 is for illustration only. Different embodiments of an example of the protection of the medium to aid a receiving DSO STA to transition to switch back to the primary channel after the end of a frame exchange could be used without departing from the scope of this disclosure.

In one embodiment, a first STA 1802 may initiate a transmission with a second STA 1804 operating in DSO mode with a DSO initial control frame, that indicates to the second STA 1804 to switch to a DSO sub-channel. At the end of the frame exchange, after sending the acknowledgement to the first STA 1802, the second STA 1804 may transition back to the primary channel. This transition may require a time indicated in the DSO Transition Delay field or DSO Switch Back Delay field by the second STA 1804. During this time, the second STA 1804 may be unable to perform channel sensing, and correspondingly may lose medium synchronization if the DSO Transition Delay is above a certain threshold. Correspondingly, in one embodiment, to ensure that the second STA 1804 does not lose medium synchronization, a SIFS duration after receiving the acknowledgement from the second STA 1804, the first STA 1802 may transmit a Padding frame 1806 to keep the medium occupied while the second STA 1804 performs the switch back to the primary channel. The Padding frame 1806 can have one or more features:
In one example, the padding frame 1806 may not solicit a response frame,
In one example, the padding frame PPDU duration may be long enough to cover the end of the unavailability of STA 2, i.e., the DSO Transition Delay starting from the end of frame exchanges in the high capability state. In one example, this duration can be at least as long as DSO Transition Delay−SIFS duration−Δ, where Δ is a predetermined constant.
In one example, the padding frame 1806 may be addressed to any STA that is available during the duration, such as the STA already being served on the primary channel. In another example, this frame can be addressed to the first STA 1802 itself as the recipient.
In one example, the padding frame 1806 can be transmitted in a specific PPDU format and at a specific MCS. For example, it can be transmitted in a non-HT duplicate PPDU format and at a rate of 6 Mbps.
In one example, the Padding frame 1806 can be transmitted only on the primary 20 MHz channel, while in another example, it may occupy the whole bandwidth of the TXOP.

In one embodiment, such medium reservation using a Padding frame 1806 may be used only under specific circumstances, as defined in the standard. Some examples of such circumstances can include:
The DSO Transition Delay of STA2 being above a certain threshold, e.g., the SIFS duration or the DIFS duration.

An illustration of this frame exchange is shown in FIG. 18. In one embodiment, the first STA 1802 may indicate a priori whether it will provide medium protection for the second STA 1804 during its transition delay. In a variant, this indication may be implicit, e.g., the first STA 1802 may announce the maximum supported DSO Transition Delay for which it will provide medium protection. Based on the indication the second STA 1804 may determine whether it has to apply any rules corresponding to loss of medium synchronization after completing the switch to primary channel. Note that the medium protection or loss of medium synchronization rules may not apply if the DSO Transition Delay is below a predetermined threshold value indicated by the standard.

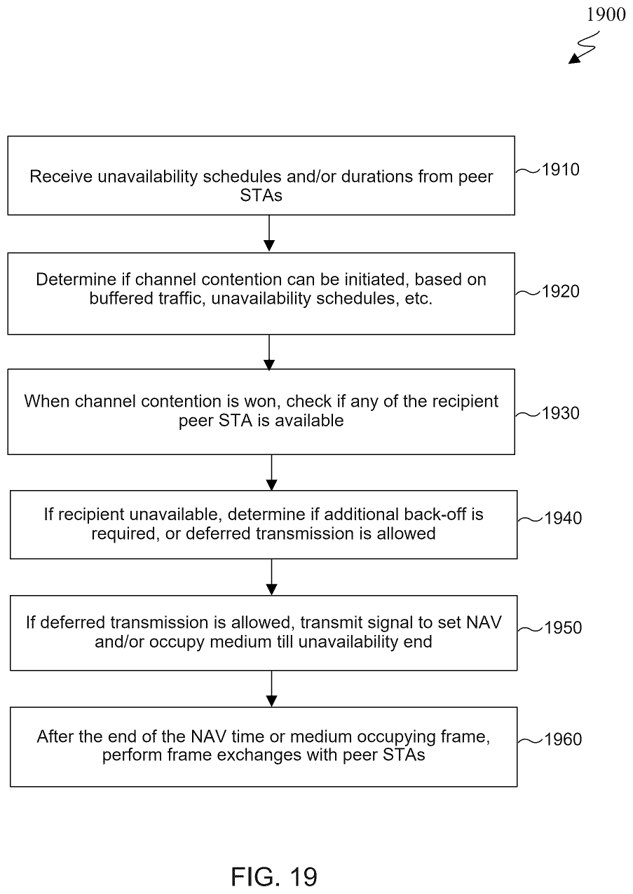

FIG. 19 illustrates a flow diagram of a method 1900 performed by a STA that initiates a TXOP when an intended recipient is unavailable for a fixed duration according to embodiments of the present disclosure. The embodiment of the method 1900 of FIG. 19 is for illustration only. Different embodiments of a method performed by a STA that initiates a TXOP when an intended recipient is unavailable for a fixed duration could be used without departing from the scope of this disclosure.

As shown in FIG. 19, the method 1900 begins at step 1910, where a STA, such as the STA 111 of FIG. 2B or the AP 101 of FIG. 2A, receives unavailability schedules and/or durations from peer STAs. At step 1920, the STA determines if channel contention can be initiated, based on buffered traffic, unavailability schedules, etc. At step 1930, when channel contention is won, the STA checks whether any of the recipient peer STAs are available. At step 1940, if the recipient is unavailable, the STA determines whether additional back-off is required, or whether deferred transmission is allowed. At step 1950, If deferred transmission is allowed, the STA transmits the signal to set NAV and/or occupy the medium until the unavailability ends. At step 1960, after the end of the NAV time or medium occupying frame, the STA performs frame exchanges with peer STAs.

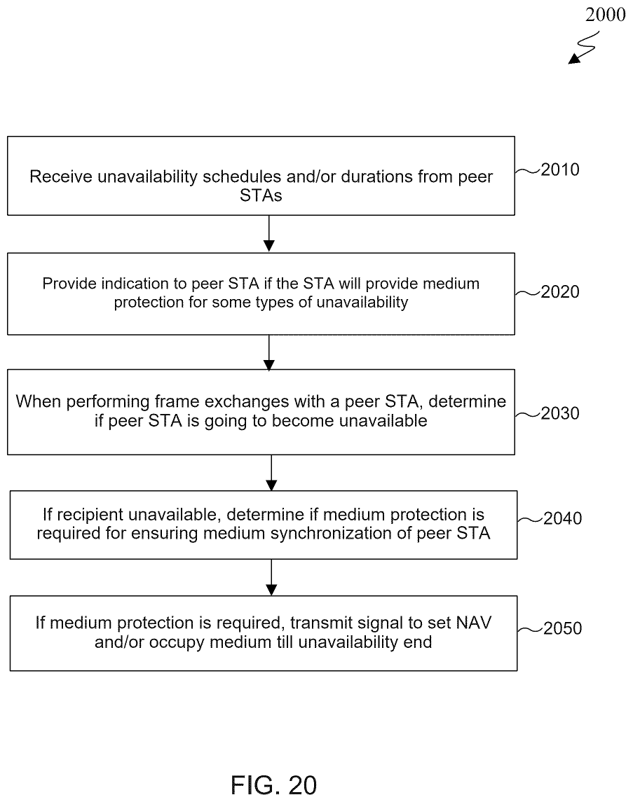

FIG. 20 illustrates a flow diagram of a method 2000 performed by a STA that reserves medium time when a peer STA becomes unavailable to prevent the peer STA from suffering from loss of medium synchronization according to embodiments of the present disclosure. The embodiment of the method 2000 of FIG. 20 is for illustration only. Different embodiments of a method performed by a STA that reserves medium time when a peer STA becomes unavailable to prevent the peer STA from suffering from loss of medium synchronization could be used without departing from the scope of this disclosure.

As shown in FIG. 20, the method 2000 begins at step 2010, where a STA, such as the STA 111 of FIG. 2B or the AP 101 of FIG. 2A, receives unavailability schedules and/or durations from peer STAs. At step 2020, the STA provides an indication to peer STAs if the STA will provide medium protection for some types of unavailability. At step 2030, when performing frame exchanges with a peer STA, the STA determines if the peer STA is going to become unavailable. At step 2040, if the recipient is unavailable, the STA determines if medium protection is required for ensuring medium synchronization of the peer STA. At step 2050, if medium protection is required, the STA transmits a signal to set NAV and/or occupy medium until unavailability ends.

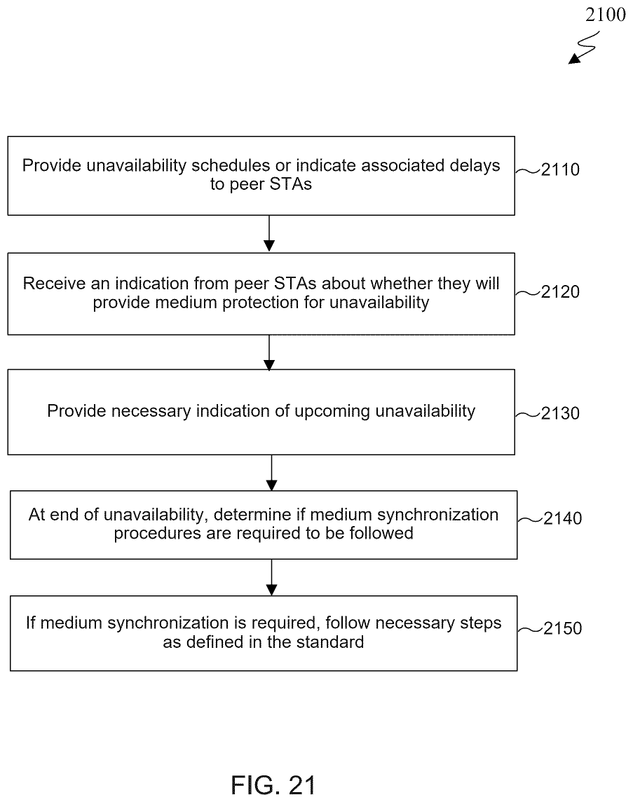

FIG. 21 illustrates a flow diagram of a method 2100 performed by a STA that has an upcoming unavailability schedule according to embodiments of the present disclosure. The embodiment of the method 2100 of FIG. 21 is for illustration only. Different embodiments of a method performed by a STA that has an upcoming unavailability schedule could be used without departing from the scope of this disclosure.

As shown in FIG. 21, the method 2100 begins at step 2110, where a STA, such as the STA 111 of FIG. 2B or the AP 101 of FIG. 2A, provides unavailability schedules or indicates associated delays to peer STAs. At step 2120, the STA receives an indication from peer STAs about whether they will provide medium protection for unavailability. At step 2130, the STA provides an indication of upcoming unavailability. At step 2040, at the end of the unavailability, the STA determines if medium synchronization procedures are required to be followed. At step 2050, if medium synchronization is required, then the STA follows any necessary steps required in the standard.

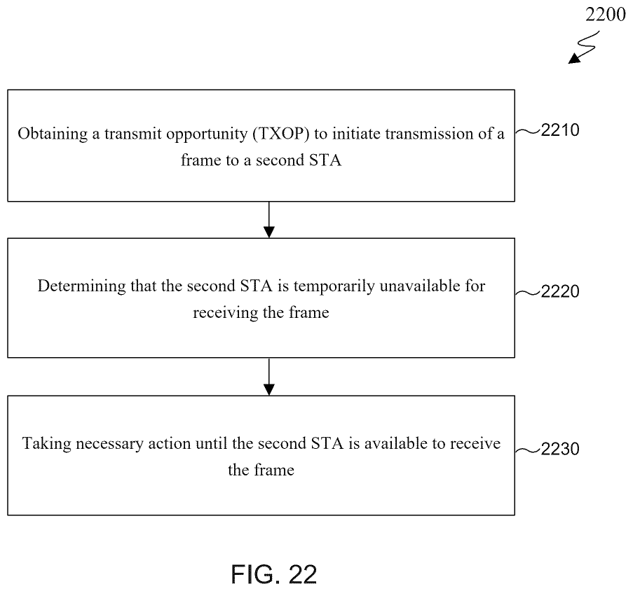

FIG. 22 illustrates an example method 2200 performed by a station (STA) in a wireless communication system according to embodiments of the present disclosure. The method 2200 of FIG. 22 can be performed by any of the STAs 111-114 of FIG. 1, such as the STA 111 of FIG. 2B, or by any of the APs 101-103 of FIG. 1, such as AP 101 of FIG. 2A. The method 2200 is for illustration only and other embodiments can be used without departing from the scope of the present disclosure.

As illustrated in FIG. 22, the method 2200 begins at step 2210, where the STA obtains a transmit opportunity (TXOP) to initiate transmission of a frame to a second STA. At step 2220, the STA determines that the second STA is temporarily unavailable for receiving the frame. At step 2230, the STA takes necessary action until the second STA is available to receive the frame.

In some embodiments, the necessary action includes at least one of: forgoing a channel access opportunity until the second STA is available, re-initiating a back-off counter for contention for channel access, and transmitting a frame to reserve medium time on a medium until the second STA is available without losing the obtained TXOP.

In some embodiments, the STA selects the necessary action based on at least one of: determining that a time between a start of channel contention for the TXOP and a time that the second STA is available satisfies a threshold, determining that a time between a time that the TXOP is obtained and a time that the second STA is available satisfies a deferral time threshold, and determining that the first STA or the second STA belong to a specific device type.

In some embodiments, the STA does not transmit a frame for reserving medium time on a medium at a time of winning a channel access opportunity and directly starts transmitting to the second STA at a time of availability of the second STA based on determining that a time between a time that the TXOP is obtained and a time that the second STA is available satisfies a deferral time threshold.

In some embodiments, the STA reserves medium time for deferred transmissions on the medium, where reserving the medium time comprises: transmitting a clear to send (CTS)-to-self frame on the medium when the TXOP is obtained; and setting a network allocation vector (NAV) duration field in the CTS-to-self frame to a function f(t2, t1), where t2 is a time that the second STA is available, and t1 is a time that the TXOP is won.

In some embodiments, the STA reserves medium time for deferred transmission on the medium, where reserving medium time comprises: transmitting a padding frame on the medium, where the padding frame includes at least one of a medium access control (MAC) header, a network allocation vector (NAV) duration field, a physical layer protocol data unit (PPDU) duration field, a padding field, an indication of a purpose of the padding frame, an indication of sub-fields present in the padding frame, an indication of a length of padding within the padding frame, and a frame check sequence field.

In some embodiments, the STA comprises determining a size of the padding frame based on at least one of: a desired duration of the padding frame based on a time that the second STA is available, a time when channel contention is initiated by the first STA, and a time that the TXOP is won, a bandwidth of transmission, a modulation and coding scheme (MCS) used for transmission, a physical layer (PHY) format of a transmitted PPDU, a size or duration of a PHY header, a size or duration of PHY tail bits, and a size of the MAC header.

In some embodiments, transmitting the frame to reserve the medium time on the medium comprises at least one of: including padding bits as sub-frames or end-of-field padding subframe within an aggregated medium access control (MAC) protocol data unit (A-MPDU), and transmitting a physical layer protocol data unit (PPDU) on the medium with padding bits included as physical layer (PHY) padding within the PPDU.

In some embodiments, the transmission of the frame to reserve the medium time is used to ensure medium synchronization is not lost at the second STA while the second STA is unavailable.

In some embodiments, a reason for the second STA unavailability includes at least one of: the second STA undergoing state transitions while operating in dynamic power save mode, the second STA performing a channel switch procedure while operating in non-primary channel access mode, the second STA performing a channel switch procedure while operating in dynamic sub-band operation mode, the second STA performing an operating mode change, and the second STA operating in one or more co-existence procedures.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a first station (STA), the method comprising:
obtaining a transmit opportunity (TXOP) to initiate transmission of a frame to a second STA;
determining that the second STA is temporarily unavailable for receiving the frame; and
taking necessary action until the second STA is available to receive the frame.

2. The method of claim 1, wherein the necessary action includes at least one of:
forgoing a channel access opportunity until the second STA is available,
re-initiating a back-off counter for contention for channel access, and
transmitting a frame to reserve medium time on a medium until the second STA is available without losing the obtained TXOP.

3. The method of claim 1, further comprising selecting the necessary action based on at least one of:
determining that a time between a start of channel contention for the TXOP and a time that the second STA is available satisfies a threshold,
determining that a time between a time that the TXOP is obtained and a time that the second STA is available satisfies a deferral time threshold, and
determining that the first STA or the second STA belong to a specific device type.

4. The method of claim 1, further comprising not transmitting a frame for reserving medium time on a medium at a time of winning a channel access opportunity and directly starting transmitting to the second STA at a time of availability of the second STA based on determining that a time between a time that the TXOP is obtained and a time that the second STA is available satisfies a deferral time threshold.

5. The method of claim 2, further comprising reserving medium time for deferred transmissions on the medium, wherein reserving the medium time comprises:
transmitting a clear to send (CTS)-to-self frame on the medium when the TXOP is obtained; and
setting a network allocation vector (NAV) duration field in the CTS-to-self frame to a function ƒ(t₂, t₁), wherein:
t₂ is a time that the second STA is available, and
t₁ is a time that the TXOP is won.

6. The method of claim 2, further comprising reserving medium time for deferred transmission on the medium, wherein reserving medium time comprises:
transmitting a padding frame on the medium, wherein the padding frame includes at least one of a medium access control (MAC) header, a network allocation vector (NAV) duration field, a physical layer protocol data unit (PPDU) duration field, a padding field, an indication of a purpose of the padding frame, an indication of sub-fields present in the padding frame, an indication of a length of padding within the padding frame, and a frame check sequence field.

7. The method of claim 6, further comprising determining a size of the padding frame based on at least one of:
a desired duration of the padding frame based on a time that the second STA is available, a time when channel contention is initiated by the first STA, and a time that the TXOP is won,
a bandwidth of transmission,
a modulation and coding scheme (MCS) used for transmission,
a physical layer (PHY) format of a transmitted PPDU,
a size or duration of a PHY header,
a size or duration of PHY tail bits, and
a size of the MAC header.

8. The method of claim 2, wherein transmitting the frame to reserve the medium time on the medium comprises at least one of:
including padding bits as sub-frames or end-of-field padding subframe within an aggregated medium access control (MAC) protocol data unit (A-MPDU), and
transmitting a physical layer protocol data unit (PPDU) on the medium with padding bits included as physical layer (PHY) padding within the PPDU.

9. The method of claim 2, wherein the transmission of the frame to reserve the medium time is used to ensure medium synchronization is not lost at the second STA while the second STA is unavailable.

10. The method of claim 1, wherein a reason for the second STA unavailability includes at least one of:
the second STA undergoing state transitions while operating in dynamic power save mode,
the second STA performing a channel switch procedure while operating in non-primary channel access mode,
the second STA performing a channel switch procedure while operating in dynamic sub-band operation mode,
the second STA performing an operating mode change, and
the second STA operating in one or more co-existence procedures.

11. An electronic device comprising:
at least one processor including processing circuitry; and
memory storing instructions, wherein the instructions, when executed by the at least one processor individually or collectively, cause the electronic device to:
obtain a transmit opportunity (TXOP) to initiate transmission of a frame from a first station (STA) to a second STA;
determine that the second STA is temporarily unavailable for receiving the frame; and
take necessary action until the second STA is available to receive the frame.

12. The electronic device of claim 11, wherein the necessary action includes at least one of:
forgoing a channel access opportunity until the second STA is available,
re-initiating a back-off counter for contention for channel access, and
transmitting a frame to reserve medium time on a medium until the second STA is available without losing the obtained TXOP.

13. The electronic device of claim 11, wherein the instructions, when executed by the at least one processor individually or collectively, cause the electronic device to select the necessary action based on at least one of:
determining that a time between a start of channel contention for the TXOP and a time that the second STA is available satisfies a threshold,
determining that a time between a time that the TXOP is obtained and a time that the second STA is available satisfies a deferral time threshold, and
determining that the first STA or the second STA belong to a specific device type.

14. The electronic device of claim 11, wherein the instructions, when executed by the at least one processor individually or collectively, cause the electronic device to not transmit a frame for reserving medium time on a medium at a time of winning a channel access opportunity and directly starting to transmit to the second STA at a time of availability of the second STA based on determining that a time between a time that the TXOP is obtained and a time that the second STA is available satisfies a deferral time threshold.

15. The electronic device of claim 12, wherein the instructions, when executed by the at least one processor individually or collectively, cause the electronic device to reserve medium time for deferred transmissions on the medium, wherein to reserve the medium time, the instructions, when executed by the at least one processor individually or collectively, further cause the electronic device to:
transmit a clear to send (CTS)-to-self frame on the medium when the TXOP is obtained; and
set a network allocation vector (NAV) duration field in the CTS-to-self frame to a function ƒ(t₂, t₁), wherein:
t₂ is a time that the second STA is available, and
t₁ is a time that the TXOP is won.

16. The electronic device of claim 12, wherein the instructions, when executed by the at least one processor individually or collectively, cause the electronic device to reserve medium time for deferred transmission on the medium, wherein to reserve the medium time, the instructions, when executed by the at least one processor individually or collectively, further cause the electronic device to:
transmit a padding frame on the medium, wherein the padding frame includes at least one of a medium access control (MAC) header, a network allocation vector (NAV) duration field, a physical layer protocol data unit (PPDU) duration field, a padding field, an indication of a purpose of the padding frame, an indication of sub-fields present in the padding frame, an indication of a length of padding within the padding frame, and a frame check sequence field.

17. The electronic device of claim 16, wherein the instructions, when executed by the at least one processor individually or collectively, cause the electronic device to determine a size of the padding frame based on at least one of:
a desired duration of the padding frame based on a time that the second STA is available, a time when channel contention is initiated by the first STA, and a time that the TXOP is won,
a bandwidth of transmission,
a modulation and coding scheme (MCS) used for transmission,
a physical layer (PHY) format of a transmitted PPDU,
a size or duration of a PHY header,
a size or duration of PHY tail bits, and
a size of the MAC header.

18. The electronic device of claim 12, wherein transmitting the frame to reserve the medium time on the medium comprises at least one of:
including padding bits as sub-frames or end-of-field padding subframe within an aggregated medium access control (MAC) protocol data unit (A-MPDU), and
transmitting a physical layer protocol data unit (PPDU) on the medium with padding bits included as physical layer (PHY) padding within the PPDU.

19. The electronic device of claim 12, wherein the transmission of the frame to reserve the medium time is used to ensure medium synchronization is not lost at the second STA while the second STA is unavailable.

20. The electronic device of claim 11, wherein a reason for the second STA unavailability includes at least one of:
the second STA undergoing state transitions while operating in dynamic power save mode,
the second STA performing a channel switch procedure while operating in non-primary channel access mode,
the second STA performing a channel switch procedure while operating in dynamic sub-band operation mode,
the second STA performing an operating mode change, and
the second STA operating in one or more co-existence procedures.
